(19) United States
(12) Patent Application Publication
(10) Pub. No.: US 2026/0061721 A1
(43) Pub. Date: Mar. 5, 2026

(54) CORRUGATED CARDBOARD PRODUCTION UNIT AND METHOD FOR INSPECTING THE FLATNESS OF CORRUGATED CARDBOARD SHEETS

(71) Applicant: BHS Corrugated Maschinen- und Anlagenbau GmbH, Weiherhammer (DE)

(72) Inventors: Thomas Münster, Vilseck (DE); Sascha-Michele Polese, Trieste (IT); Stefan Trenz, Neuhaus (DE)

(21) Appl. No.: 19/101,673

(22) PCT Filed: Jul. 28, 2023
(86) PCT No.: PCT/EP2023/070952

§ 371 Date: Feb. 6, 2025

(30) Foreign Application Priority Data
Aug. 11, 2022 (DE) 10 2022 208 363.6

(51) Int. Cl. B31F 1/28; G01B 11/30

(52) U.S. Cl. CPC B31F 1/284; G01B 11/306

(57) ABSTRACT

The invention relates to a corrugated cardboard production unit (2) and to a method for monitoring such a corrugated cardboard production unit (2), wherein the sheets (6) are placed so as to lie partially on top of one another on a conveyor belt (10) extending in a longitudinal direction (8), so that an end-face edge (26) of a leading sheet (6) rests on a trailing sheet (6). A defined region of a conveyor device (4) of the corrugated cardboard production unit (2) is specified as a test region (12), and images (I) of the test region (12) are captured by means of a camera (22). When viewed in the longitudinal direction (8), the camera (22) is oriented upstream and obliquely towards the test region (12) and thus towards the end-face edge (26) of a sheet (6) located in the test region (12). On the basis of at least one of the captured images (I), the course of the end-face edge (26) is analyzed with regard to a deviation from the flatness of the sheet (6) by means of an automatic image analysis.

The invention relates to a corrugated cardboard production unit and to a method for inspecting the flatness of corrugated cardboard sheets.

Corrugated cardboard production units are well known and are used for producing individual sheets made of corrugated cardboard. During the production of the sheets, the aim is to achieve the best possible flatness of the individual sheets, since this is a decisive criterion in terms of quality and further processing. Flatness is understood here to mean that a particular sheet is designed to be flat and without any bend. A deviation from such a flatness in the form of a curvature is also referred to as a “warp”.

In EP 1 473 147 A1, an undesired curvature of the sheets is detected by means of a camera-based system. The height levels of various points on a sheet are detected and analyzed. The inspection of the sheets with regard to a deviation from flatness is also referred to below as “warp detection”.

Camera-based systems for monitoring a corrugated cardboard production unit and checking the corrugated cardboards produced are also generally known. Markers are applied to the corrugated cardboard. For example, DE 10 2015 204 407 A1 describes a luminescent marker system.

The detection of a deviation from the flatness requires a high degree of accuracy in order to obtain reliable information about such a deviation in such a camera-based monitoring system.

Based thereon, the object of the invention is to ensure with little effort a reliable automatic inspection of the flatness of the sheets produced in a corrugated cardboard production unit.

The object is achieved according to the invention by a method for monitoring the flatness of corrugated cardboard sheets, wherein
a) the sheets are placed partially on top of one another on a conveyor belt extending in a longitudinal direction and are conveyed in the longitudinal direction so that an end-face edge of a leading sheet rests on a trailing sheet,
b) a defined region of a conveyor device of the corrugated cardboard production unit is specified as a test region,
c) at least one camera is provided, which captures images of the test region, wherein
d) when viewed in the longitudinal direction, the camera is positioned upstream of the test region and is oriented obliquely towards the test region and thus towards the end-face edge of a sheet located in the test region,
e) on the basis of at least one of the captured images, the course of the end-face edge is analyzed by means of an automatic image analysis, namely with regard to a deviation of the corresponding sheet from the flatness of this sheet.

The object is furthermore achieved according to the invention by a corrugated cardboard production unit in which
at least one conveyor device extending in a longitudinal direction is arranged for conveying corrugated cardboard sheets, wherein the sheets are placed so as to lie partially on top of one another on the conveyor belt during operation, so that an end-face edge of a leading sheet rests on a trailing sheet,
a defined region of the conveyor device is specified as a test region,
at least one camera is arranged, which is designed to capture images of the test region, wherein
when viewed in the longitudinal direction, the camera is positioned upstream of the test region and is oriented obliquely towards the test region and thus towards the end-face edge of a sheet located in the test region,
an analysis unit is arranged, which is configured to analyze the course of the end-face edge with regard to a deviation from flatness of the sheet by means of an automatic image analysis on the basis of at least one of the captured images.

The advantages and preferred embodiments presented below with regard to the method also analogously apply to the corrugated cardboard production unit and vice versa.

For the corrugated cardboard production unit and the method, it is of particular importance that, on the one hand, the camera position is arranged upstream and obliquely in front of the test region so that the line of sight of the camera is directed from the front towards a particular overlapping end-face edge of the particular sheet. Preferably, the conveyor device is provided with lighting so that the end-face edges or a corresponding shadow make the end-face edges clearly visible in the image. This makes reliable, automatic image analysis of the course and thus of the profile of the end-face edge possible. The course of the end-face edge in the transverse direction, i.e., perpendicular to the longitudinal direction, can be used to immediately recognize curvatures and bulges that are formed on the end-face edge of the particular sheet and to analyze them as a characteristic value for a deviation from flatness.

For warp detection, only the analysis described in detail below of the course of the end-face edge is preferably used.

The analysis unit is configured and designed accordingly and in particular has a processor, typically a data memory, and in particular one or more suitable algorithms by means of which the automatic image analysis is carried out.

In contrast to the prior-art height measurement, in which the particular sheet is viewed from above and a distance measurement to a reference height is carried out, such an edge analysis is possible with simple means and with high reliability with regard to the desired warp detection. In particular, a height measurement is therefore dispensed with.

Another significant advantage of the described method and of the described corrugated cardboard production unit is that the camera can be used to obtain a large amount of additional information at the same time, so that the camera can be and preferably also is used for further monitoring tasks, both automatic and manual ones. Overall, this edge analysis measure therefore keeps the total monitoring and system effort for checking the corrugated cardboard production unit during the production of corrugated cardboard to a minimum.

For example, by identifying each end-face edge, an individual identification of each sheet, specifically of a sheet end, is also immediately implicitly made possible and provided. In the case of mere height detection, an identification of each sheet must additionally be provided in order to be able to reliably assign the measured distance profile to the corresponding sheet.

According to a first embodiment, the camera is used to capture individual images and, in a second embodiment, image sequences are created and further processed in the form of a stream.

The conveyor device is in particular a part of the corrugated cardboard production unit in the region of the so-called dry end. Specifically, the conveyor device is part of a delivery system, which is arranged downstream of a cross-cutter, which divides the continuous corrugated cardboard produced into individual sheets. The sheets are deposited in the delivery system onto one or more conveyor belts, also known as delivery belts, and conveyed further, for example to a stacking apparatus. The individual sheets are deposited and conveyed in an overlapping arrangement. Therefore, they are placed on top of one another in a shingle-like manner. This is also referred to as a shingled arrangement below.

A plurality of conveyor belts are often provided, which are provided next to one another and, in particular, one above the other. In such a case, at least one camera is installed at each conveyor belt. The at least one camera is oriented with a special partial region of the conveyor device and in particular the conveyor belt, which forms the test region of the conveyor device. This means that the camera images a partial region of the conveyor device in a particular captured image. The camera is adjusted such that at least part of the captured image images the test region.

According to a preferred embodiment, an edge extraction is carried out to identify the particular end-face edge and an extracted end-face edge is obtained. A suitable executable program/algorithm is therefore installed in the analysis unit and is used to carry out the edge extraction automatically. Such algorithms for recognizing and extracting edges in a captured image are basically known and are also referred to as edge detection filters. For example, the points with a specified brightness change in the captured image, specifically a gray-scale image, are determined. Such algorithms allow reliable identification of the course of the end-face edge.

In a next step, the extracted end-face edge is preferably analyzed with regard to the deviation from flatness. For this purpose, the course of the end-face edge is analyzed, in particular with regard to maximum values, minimum values, deviations from a mean value, curvature behavior, etc.

The extracted end-face edge is expediently approximated by means of a curve fit and thus by a mathematical function. This mathematical function is then analyzed with regard to the deviation from flatness. Specifically, the aforementioned parameters, at least some of them, are analyzed by a functional analysis, such as by taking derivatives, etc.

The curve fit is, for example, a polynomial fit of higher order. Preferably, a so-called spline interpolation is carried out. This interpolation is particularly suitable for warp detection since very strong curvatures, which can be well approximated by spline interpolation, can occur in the sheets, for example due to grooving.

According to a preferred embodiment, the sheets are furthermore analyzed with regard to twisting, preferably on the basis of the identified and extracted end-face edge. The sheets are regularly oriented in parallel with the longitudinal direction and have edges and structures running in the longitudinal direction, for example the outer edges, a groove or a longitudinal cutting edge. The end-face edge is typically designed as a transverse edge, which runs transversely to such longitudinal edges of the sheet and is therefore also oriented transversely to the longitudinal direction of the conveyor belt when properly deposited on the conveyor belt. When analyzing whether the sheets are twisted, the image analysis is now used to automatically inspect whether the end-face edge runs transversely to the longitudinal direction. For this purpose, for example, the length of the end-face edge, i.e., its extension in the transverse direction, is measured by means of the automatic image analysis and is compared with a target value. The target value results from the (known) width of the particular sheet and the imaging geometry of the camera. The width of the sheet is preferably read from the production unit control system and used for the analysis. In the case of a twist, the measured edge length is less than the target value. The difference to the target value is preferably also used to deduce the degree of twisting. If a twist is identified, specifically a twist that exceeds a limit value, a warning message is in particular issued. According to a preferred development, when a twist is identified, the degree of twisting is also determined.

Finally, in a preferred embodiment, the warp detection automatically takes into account the previously identified rotation. For example, after an identified rotation, an image correction is therefore carried out first to compensate for the rotation. For this purpose, for example, the image is rotated so that the previously measured twisting of the sheet is compensated and thus reversed. This measure makes reliable analysis of the extracted end-face edge possible.

In order to keep the design for detecting the deviation from flatness as simple as possible, height measurement is dispensed with. In a height measurement, a distance from a reference level to, in particular, a plurality of surface regions of the sheet is usually measured. By dispensing therewith, the technical equipment-related effort is kept to a minimum.

In a preferred embodiment, a plurality of markers, which are correlated with and in particular delimit the test region, are fixed in place in the region of the conveyor belt. The camera also, in particular, captures the markers so that they are contained in the captured image. The markers may be passive or active markers. Active markers have active luminous elements, such as (LED) light sources. Passive markers lack such luminous elements. Passive markers are, for example, colored markings or reflective elements. These passive markers are fixed to the edge side of the conveyor belt, for example in the form of films.

As an alternative or in addition to the markers, the test region is defined by a defined setting and configuration, for example when commissioning the production unit. This includes, for example, a defined orientation of the camera with respect to the conveyor device.

On the basis of the markers, it is also preferably inspected by means of the automatic image analysis whether the test region depicted in the captured image is oriented according to a specified target orientation. This measure in particular inspects the technical equipment-related adjustment, specifically the adjustment of the camera in relation to the conveyor belt. Changes in the camera position during operation, for example due to vibrations etc., and any resulting misalignment are therefore detected. Preferably, an automatic correction is carried out when such a deviation of the depicted test region from the target orientation is detected. If, for example, it is detected that the depicted test region is twisted or distorted compared to its target orientation, an appropriate image transformation which reverses this twisting/distortion is carried out. This is preferably carried out prior to the edge extraction and its analysis.

By arranging the camera obliquely in front of the test region, the captured images regularly show a perspective, specifically a so-called vanishing point perspective. This is understood to mean that parallel structures extending in the longitudinal direction converge towards an imaginary vanishing point. In a preferred development, it is now provided that, before inspecting the captured image for any deviation of the sheets from flatness, a correction of this vanishing point perspective is automatically carried out. This is understood to mean that the captured image is automatically processed by an appropriate image transformation to the effect that edges that are actually parallel are also parallel to one another in the captured image. In particular, this also means that the captured perspective image is converted into a top-view image. Such a correction is in particular of particular importance if the sheets deposited on the conveyor belt extend only over part of the width of the conveyor belt and are arranged on the edge side. The camera is generally preferably arranged centrally with respect to the conveyor belt. Due to the arrangement of the camera in front of the test region, the off-center arrangement of the sheets leads to a certain distortion, which can lead to errors in edge recognition and edge analysis if the appropriate correction of the vanishing point perspective is not carried out.

In a corrugated cardboard production unit, a plurality of individual sheets are often arranged next to one another on the conveyor belt. These individual sheets are also called panels. They are created, for example, by dividing a sheet lengthwise into different individual sheets. In a preferred development, it is now provided that automatic recognition of these individual sheets takes place and is carried out. For this purpose, the automatic image analysis is used to analyze the captured image with regard to longitudinal structures, for example cutting edges or grooves that run in the longitudinal direction. Here too, in a preferred embodiment, automatic edge extraction is again carried out.

In this case, the brightness contrasts are often less pronounced than at the end-face edges, making edge recognition more difficult. In a preferred development, information from a production unit control system is therefore used, which is taken into account for the automatic image analysis. This information is, in particular, information as to where grooving or cutting is carried out. Specifically, the position of the cutting blade is taken from the production unit control system and taken into account for the image analysis. As a result, it is possible to clearly delimit the image region to be examined with regard to longitudinal structures. Another piece of information is, for example, the width of each individual sheet, which width is known and stored in the production unit control system.

If a plurality of such individual sheets are arranged next to one another on the conveyor belt, each of these individual sheets arranged next to one another is preferably analyzed with regard to a deviation from flatness, as previously described.

In an expedient design, the camera is used at the same time for a visual monitoring system, which is designed for the visual, manual monitoring of the corrugated cardboard production unit by operating personnel. Specifically, for this purpose, the images captured by the camera are displayed on a monitoring monitor of the monitoring system, which monitor is monitored by the operating personnel. This makes a visual manual check of the corrugated cardboard production unit and specifically of the conveyor device possible, in particular in real time. The perspective arrangement of the camera obliquely in relation to the conveyor belt allows for a good overall overview of the conveyor device and the sheets being conveyed.

For the intended inspection of the sheets with regard to a deviation from flatness, the camera has a high resolution overall, which is in the millimeter range. This is understood to mean that neighboring image points shown in the image depict and resolve two actual points of the conveyor device that are only a few millimeters apart, in particular in the range of 1-5 mm.

The test region depicted in the image typically extends over the entire width of the conveyor belt. This width is typically in the range between 100 cm and 400 cm and in particular in the range between 250 and 350 cm. Furthermore, the test region has a depth in the longitudinal direction that is preferably less than 1 m and in particular in a range between 40 cm and 75 cm. Depending on the arrangement of the camera, the depth can also be greater.

According to the invention, a corrugated cardboard production unit is also designed with the features of claim 15. This combination of features represents an independent invention. The submission of a divisional application for this remains reserved. The aspects described below in connection with this further invention also represent preferred further developments of the previously described corrugated cardboard production unit and the previously described method.

According to this aspect, an enclosure is attached in the region of the test region, which at least partially covers the conveyor device, at least the conveyor belt, and spans it in the transverse direction at right angles to the longitudinal direction. Using this enclosure, a targeted shading of the test region from the surroundings is carried out, so that the test region is at least partially protected and shaded from incident light, specifically from the side or from above. Furthermore, a lighting element is provided to illuminate the test region and specifically the end-face edge in a defined manner. This measure improves the visibility of the test region and in particular of the end-face edge so that the automated image analysis is more reliable and more accurate.

A further advantage of the enclosure is also seen in the fact that, in addition to providing optical shading, it also offers protection for the test region, for example, against contamination.

In a preferred embodiment, the lighting element can be dimmed, so that the light intensity can be set. In this manner, an adjustment of the light intensity to the ambient lighting conditions is facilitated and also undertaken during operation.

Alternatively or additionally, the light color can be set. In this manner, the recognizability of structures in the test region for the camera can be improved on a targeted basis. Specifically when using passive markers, the recognizability of the markers can be improved by selecting the light color.

The lighting element is preferably attached to the enclosure, particularly on the inner side. In a preferred embodiment, the enclosure generally has at least one side wall and preferably two side walls and an upper wall. The upper wall preferably spans the entire width of the conveyor belt. In particular, it connects the two side walls. They are fastened on the edge side of the conveyor device, for example. Overall, the enclosure is L-shaped and preferably U-shaped in a view in the direction of the longitudinal direction. Due to the arrangement on an inner side, and in particular on the inner side of the upper wall, a targeted illumination of the region shaded by the enclosure is achieved.

In a preferred embodiment, the lighting element is attached and/or shaded such that the lighting element is not visible to the camera and/or that the light output by the lighting element does not shine into the camera. The term “not visible” is understood to mean that the lighting element is not recognizable in the image captured by the camera. At the very least, the lighting element, specifically a cone of light output by the lighting element, is oriented such that it does not shine into the camera. In this manner, good recognizability of the illuminated test region is ensured, in particular without any overexposure (excessive brightness) of partial regions in the image captured by the camera. In order to realize this shading of the lighting element in the direction of the camera, for example, an aperture is provided.

With regard to the best possible shading of the test region, the enclosure is made of a visually non-transparent, opaque material.

The enclosure is preferably only formed in the region of the test region, so it only extends over a section of the conveyor device. It is specifically adjusted, for example, to the length of the test region in the longitudinal direction and has a length that corresponds to a range between 0.5 times and twice the length of the test region. Preferably, the length corresponds, for example, to 0.7-1.5 times the length of the test region.

The height of the enclosure is preferably in a range between 0.2 m and, for example, up to a maximum of 1 m and is preferably in a range of less than 0.7 m or even less than 0.5 m—relative to the height of the conveyor belt. Overall, in this manner, a comparatively narrow region of the conveyor device is shaded and thus optimally protected from ambient light.

In a preferred embodiment, the lighting element extends transversely to the longitudinal direction and has a plurality of individually controllable regions. Therefore, the individually controllable regions can be used to illuminate defined transverse regions on a targeted basis. This is particularly useful if the entire width of the conveyor device is not utilized, i.e. if the overlying sheets do not cover the entire width.

The lighting element specifically has a plurality of light-emitting elements. Individual LEDs are preferably used as light-emitting elements. The light-emitting elements can be controlled either individually or in groups in order to form the controllable regions.

The various options described above, for example the dimmability for setting a suitable illumination intensity, the setting of the light color (specifically through the use of RGB light sources), are preferably also implemented during operation of the unit, i.e. during the carrying out of the method, and carried out individually or in any combination.

An exemplary embodiment of the invention is explained in more detail below with reference to the figures. The figures show, in sometimes highly simplified representations:

FIG. 1 a conveyor device as part of a corrugated cardboard production unit in a lateral cross-sectional view,

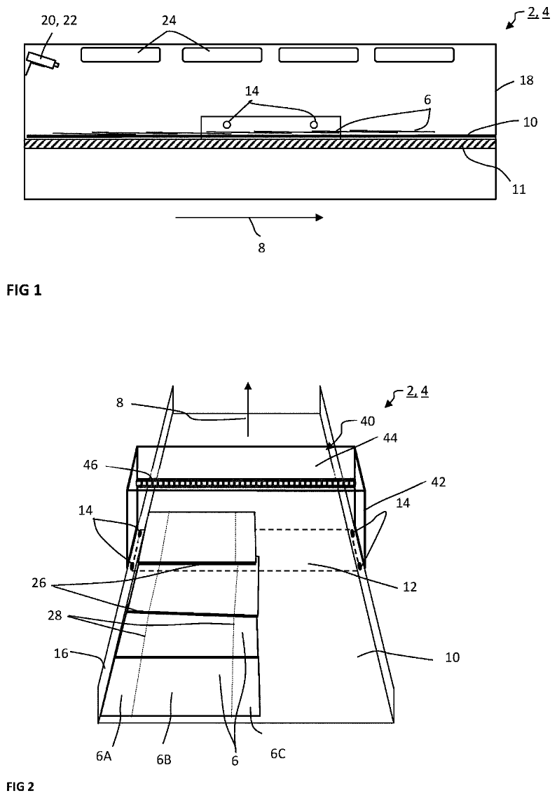

FIG. 2 a perspective top view of a conveyor belt in the line of sight of a camera,

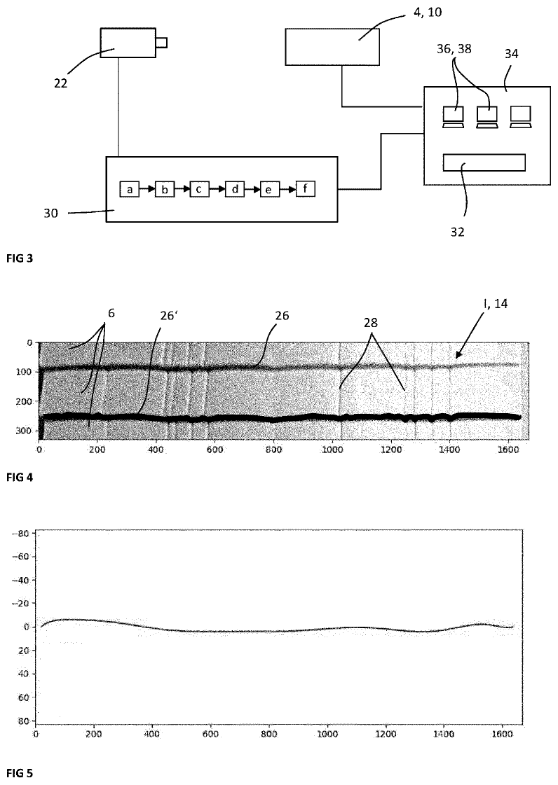

FIG. 3 a schematic block diagram of parts of the corrugated cardboard production unit,

FIG. 4 a captured image of a test region with an extracted end-face edge, and

FIG. 5 the result of a curve fit, which reproduces the course of the extracted end-face edge.

FIG. 1 and FIG. 2 show, in highly simplified representations, as a section of a corrugated cardboard production unit 2, a partial region of a conveyor device 4, by means of which individual sheets 6 made of corrugated cardboard are conveyed and transported in a conveying direction. The conveying direction simultaneously defines a longitudinal direction 8 of the conveyor device 4. The conveyor device 4 has a conveyor belt 10, which is guided by a belt carrier 11.

The individual sheets 6 lie on the conveyor belt 10, overlapping one another by a section in the longitudinal direction 8 in each case. Therefore, they are placed on top of one another in a shingle-like manner. This overlapping arrangement is also referred to as a shingled arrangement below. During operation, the conveyor belt 10 runs continuously, so that the sheets 6 are conveyed continuously in the longitudinal direction 8. The conveyor belt 10 has a width transverse to the longitudinal direction 8, which width is typically in a range between 100 cm and 400 cm and in particular in a range between 250 cm and 350 cm. This width defines the maximum corrugated cardboard width that can be produced with the corrugated cardboard production unit 2. In the exemplary embodiment, the width of the sheets 6 is significantly smaller than the width of the conveyor belt 10.

The conveyor device 4 is assigned a specified partial region as a test region 12. This is shown by dashed lines in FIG. 2. This is preferably a rectangular partial region of the conveyor device 4, specifically the conveyor belt 10. In the exemplary embodiment, markers 14 are provided at the corner points of the test region 12, on the edge side of the conveyor belt 10. For example, they are integrated in a flange 16 on the edge side. In principle, they are mounted in a fixed position on the conveyor device 4. Alternatively, the test region 12 is defined by a defined configuration and orientation, e.g., of the camera 22.

The conveyor device 4 also generally has a support frame 18 (see FIG. 1), via which the conveyor device 4 is fastened to a floor, for example, and which is also designed for mechanically supporting the conveyor belt 10. Only one conveyor belt 10 is shown in the exemplary embodiment. However, conveyor devices 4 often have a plurality of conveyor belts 10, which are provided one above the other or next to one another, for example. Typically, a particular conveyor belt 10 is provided in a manner inclined at an angle and conveys the sheets 6 to a higher level. Following the conveyor belt 10, a stacking apparatus is typically provided for stacking the individual sheets 6.

Furthermore, a camera system 20, which has at least one camera 22 and is formed by this camera in the exemplary embodiment, is assigned to each conveyor belt 10. The camera 22 is positioned against the longitudinal direction 8 in front of the test region 12 and slightly above the conveyor belt 10. The camera 22 is oriented in the direction of the test region 12, i.e. a detection region of the camera 22 is oriented towards the test region 12.

Preferably, the camera 22 is generally a CCD camera having a suitable CCD sensor with a suitable pixel density. A resolution of the camera 22 is sufficiently high. Specifically, the resolution is in the millimeter range, i.e., two neighboring image points in the captured image I represent an actual distance (of the test region 12) in a range of a few millimeters, in particular in a range of 1-5 mm.

Typically, the conveyor device 4 has a lighting apparatus 24 comprising at least one lighting element, using which at least a partial region and in particular the test region 12 is suitably illuminated. A plurality of lighting elements are shown in the exemplary embodiment in FIG. 1. Due to the illumination of the test region 12, it is ensured that the images I captured by the camera 22 (cf., for example, FIG. 4) are of sufficient quality for the intended image analysis. Depending on the design of the markers 14, specifically if they are designed as reflective elements or as luminescent elements, the lighting also ensures that the markers 14 are easily recognizable in the captured image I. For example, a lighting element is positioned in the region of the camera 22 and illuminates the markers 14 from there. However, active markers 14, which have a luminous element, such as an LED, are preferably used as markers 14.

Due to the shingled arrangement of the individual sheets 6 and the illumination, an end-face edge 26 of a particular sheet 6 can be easily recognized by a high light/dark contrast (cf. in particular FIG. 2 and FIG. 4). FIG. 2 furthermore shows that the sheets 6 are grooved and/or cut in the longitudinal direction 8. This is shown for each individual sheet 6 by two dashed cutting lines 28. If a particular sheet 6 is completely severed, a plurality of individual sheets 6A, 6B, 6C are created, which are usually also referred to as panels. Unless otherwise stated, the following embodiments relate to a variant in which each sheet 6 is merely grooved and not divided into individual sheets 6A, 6B, 6C.

Normally, the sheets 6 are oriented in the longitudinal direction 8, i.e., the cutting lines 28 and/or their edge-side edges are typically oriented in parallel with the longitudinal direction 8.

However, when the individual sheets 6 are deposited on the conveyor belt 10, it can sometimes happen that individual sheets 6 are rotated out of this target position, as is shown in a simplified manner with one of the sheets 6.

A corrugated cardboard production unit 2 generally consists of a plurality of components. Using the corrugated cardboard production unit 2, a continuous corrugated cardboard is initially produced from paper webs, which is then cut for producing the individual sheets 6. The structure and mode of operation of such a corrugated cardboard production unit 2 is known in principle and typically as follows:

The paper webs are unwound from a dispenser and fed to the further downstream components of the corrugated cardboard production unit 2. For uninterrupted operation, so-called splicers are provided, for example, which make uninterrupted operation possible even when changing paper rolls.

Using a so-called single-sided machine (single facer), a single-sided corrugated cardboard web is initially produced. Here, one of the paper webs is grooved using a corrugated roller and then glued to a first cover web on one side. This paper web is usually fed via a so-called bridge to other machines for further processing, and a second cover web is usually glued opposite the first cover web onto the corrugated layer of the single-sided corrugated cardboard web. For this purpose, the second cover web is typically first fed into a so-called preheater. A gluing unit is provided for gluing. In order to make quality and trouble-free operation possible, heating apparatuses, pulling apparatuses and other belt guides are also preferably provided for guiding the paper webs and/or the corrugated cardboard web produced. The portion of a corrugated cardboard production unit up to the production of double-sided corrugated cardboard is referred to as the wet end.

This is followed by the dry end. Here, the previously produced continuous corrugated cardboard web is processed and cut to size. Typically, a so-called short cross-cutter is initially provided, which is used to remove the so-called start-up waste during a format change, for example. Furthermore, the dry end has an automatic cutting and creasing machine, in particular downstream of the short cross-cutter, which machine cuts or at least creases the corrugated cardboard web in the longitudinal direction and thus inserts defined click regions.

Finally, a so-called cross-cutter is arranged downstream, which severs the corrugated cardboard web in the transverse direction in order to produce the individual sheets 6. The delivery system, which has the conveyor device 4 described above, is also arranged downstream of the cross-cutter. The stacking apparatus for stacking the individual sheets 6 is typically provided downstream of the conveyor device 4.

The specific design of the corrugated cardboard production unit 2 and the method for monitoring the corrugated cardboard production unit, in particular with regard to monitoring whether there is a deviation from the flatness of the individual sheets 6, are explained in more detail below, in particular in connection with FIG. 3, FIG. 4 and FIG. 5:

According to FIG. 3, the camera 22 is connected to an analysis unit 30, which in the exemplary embodiment is also connected to a production unit control system 32. This production unit control system is arranged, for example, in a monitoring room 34, which is equipped with a number of monitors 36, which are part of a manual visual monitoring system 38. The images captured by the camera 22 are displayed on one of the monitors 36, in particular as a live stream, so that the production unit can be visually monitored by the operating personnel.

The production unit control system 32, which can also be divided into a plurality of control units, controls the operation of the corrugated cardboard production unit 2 and in particular also of the conveyor device 4. The analysis unit 30 shown separately in FIG. 3 can be part of the production unit control system.

For warp detection, i.e., for analyzing whether the sheets 6 deviate from flatness, images I (cf. FIG. 4) are continuously captured by means of the camera 22. For example, these images can be individual images or a stream.

A total of 22 images are captured by the camera at a suitable capture rate (frame rate). The capture rate, for example, is in a range of 30 to 60 frames per second (30 Hz-60 Hz). In principle, cameras with higher or lower capture rates can also be used.

The captured images I, i.e., the corresponding electronic image data, are transmitted to the analysis unit 30. The analysis unit 30 is suitably configured to carry out automatic image analysis and image processing. For this purpose, the analysis unit 30 has at least one suitable processor, one or more suitable algorithms and also a memory.

The process of image processing and image analysis has the following steps in particular:
In a step a, for example, a first image correction is carried out, in which distortions caused by the camera lens are corrected.
In a step b, the markers 14 are detected and the test region 14 is determined in the captured image I.
In a further step c, a first analysis is carried out. For example, it is inspected whether the test region 14 shown in the captured image I is oriented according to a target orientation. If this is not the case, an image correction is preferably carried out, for example a rotation or distortion of the captured image I.

Furthermore, the identified test region 14 is preferably extracted, for example by cropping the image I to the test region 14 identified in the image I.

Finally, in this step c, a correction of the vanishing point perspective is preferably carried out. In doing so, an image transformation is in particular carried out so that the perspective representation determined by the camera position is transformed into a top view.

These previously mentioned steps a to c are preparatory steps for image processing prior to the actual warp inspection, which is carried out in the following steps:
In step d, for example, a particular sheet 6 is first generally captured and identified as such. This is carried out, for example, by recognizing the end-face edge 26 shown.

In the following step e, edge recognition is carried out by means of a suitable algorithm so that the course of the end-face edge 26 in the captured image I is identified and extracted. This is shown as an example in FIG. 4 with the lower end-face edge 26 by the bold line, which depicts the identified course of the end-face edge 26 and thus forms an extracted end-face edge 26′.

FIG. 4 generally shows the image I prepared according to steps a to c, in which the extracted end-face edge 26′ is additionally shown.

In the following step f, the identified course of the end-face edge 26 is again analyzed with the support of suitable algorithms. For this purpose, in a first step, a mathematical approximation of the extracted end-face edge 26′ is carried out so that the course of the end-face edge 26 is described by a mathematical function. The result of this mathematical approximation is shown as an example in FIG. 5. The curve obtained by the mathematical approximation is plotted on the y-axis around a zero position. The x-axis represents the extension of the end-face edge 26 in the transverse direction.

Based on this mathematical function, a functional analysis is subsequently carried out in order to derive characteristic values for the course of the end-face edge 26. These characteristic values are in particular maximum values, minimum values, distances between these maximum and minimum values, curvature values, a (for example moving) mean value and preferably also statistical characteristic values, such as (standard) deviation from the mean value. One or more of these characteristic values are used for the analysis. Target values are specified for the different characteristic values. If these target values are exceeded, an impermissible deviation from flatness is recognized and a corresponding error message is issued. Additionally or alternatively, the characteristic values characterizing the course are output and/or stored, in particular also in connection with the captured underlying image I.

In addition to this identification and analysis of the flatness, the sheets 6 are preferably also monitored for further properties or errors during the automatic image analysis on the basis of the image I captured by means of the camera 22:
For example, it is monitored whether the sheets 6 are oriented in their respective target orientation, i.e., typically whether they are oriented in parallel with the longitudinal direction 8. The end-face edge 26 is typically perpendicular to the longitudinal direction 8 in each case. For analyzing the target orientation, for example, the length of the end-face edge 26 in the image I is measured by means of the image analysis. If this length is smaller than a target length, this indicates that the sheet 6 is twisted.

In the event that a plurality of individual sheets 6A, 6B, 6C are arranged next to one another, an automatic identification of the individual sheets 6A, 6B, 6C is preferably also provided. Furthermore, the analysis of the course of the end-face edge 26 for detecting a deviation from flatness is carried out individually for each individual sheet 6A, 6B, 6C, as previously described in connection with sheet 6.

For identifying the individual sheets 6A, 6B, 6C, the image analysis is preferably used to analyze the captured image I with regard to the cutting lines 28 oriented in the longitudinal direction 8. This is again carried out by means of edge recognition. Preferably, additional information is used via the production unit control system 32, for example information about the position of cutting blades with which the cutting lines 28 are introduced, and/or about the width of the particular sheets 6 or individual sheets 6A, 6B, 6C. On the basis of this additional information, the analysis is focused on only limited image regions so that the computational effort is reduced and the analysis quality is improved at the same time.

In connection with FIG. 2, an enclosure 40 is formed in the region of the test region 12 as a preferred further development, but also as an independent invention. In the exemplary embodiment, this enclosure 40 is designed to be U-shaped and has two side walls 42 and an upper wall 44, which connects the two side walls 42 to one another. The enclosure 40 spans the entire width of the conveyor device 4 in the test region 12. In the exemplary embodiment, the enclosure 40 has a length in the longitudinal direction 8 that corresponds to the length of the test region 12. A lighting element 46 is provided on the inner side of the upper wall 44 and extends transversely across the conveyor belt 10. The lighting element 46 has individual light-emitting elements, in particular individual LEDs, which are lined up next to one another in the transverse direction. Therefore, the lighting element 46 is a type of LED bar. The lighting element 46 can be dimmed and is preferably also dimmed as a function of the current lighting situation during operation. Furthermore, in a preferred development, there is also the possibility of setting the color, which is preferably also suitably selected during operation in order to allow the recognizability of desired structures within the test region 12 to stand out clearly in the camera image. Specifically, this improves the visibility of the end-face edge 26 and/or of the markers 14. The lighting element 46 has individually controllable regions or segments, which are preferably provided next to one another in the transverse direction. In particular, in each case these regions are groups of individual LEDs.

Due to this embodiment, the test region 12 is suitably illuminated as a function of the current requirements and lighting situation, wherein the intensity and/or the color are set appropriately for this purpose. With the desired edge recognition, this in particular achieves a better prominence of the shadow cast by the end-face edge 26. Due to the enclosure 40, the test region 12 is protected from stray light and other sources of interference from outside as well as from contamination. A cone of light output by the lighting element 46 is preferably oriented obliquely in a downward direction, namely preferably overall such that a shadow cast by the end-face edge 26 stands out as much as possible.

### LIST OF REFERENCE SIGNS

2 Corrugator
4 Conveyor device
6 Sheet
6A, B, C Individual sheet
8 Longitudinal direction
10 Conveyor belt
11 Belt carrier
12 Test region
14 Marker
16 Flange
18 Support frame
20 Camera system
22 Camera
24 Lighting apparatus
26 End-face edge
26′ Extracted end-face edge
28 Cutting line
30 Analysis unit
32 Production unit control system
34 Monitoring room
36 Monitor
38 Manual monitoring system
40 Enclosure
42 Side wall
44 Upper wall
46 Lighting element
I Captured image

1. A method for monitoring a flatness of corrugated cardboard sheets in a corrugated cardboard production unit, the method comprising:
a) placing the sheets so as to lie partially on top of one another on a conveyor belt extending in a longitudinal direction, so that an end-face edge of a leading sheet rests on a trailing sheet;
b) specifying a defined region of a conveyor device of the corrugated cardboard production unit as a test region;
c) capturing images (I) of the test region with at least one camera, wherein, when viewed in the longitudinal direction, the camera is positioned upstream of the test region and is oriented obliquely towards the test region and thus towards the end-face edge of an inspected sheet located in the test region; and
d) analyzing, on the basis of at least one of the captured images (I), the course of the end-face edge analyzed with regard to a deviation from the flatness of the inspected sheet by means of an automatic image analysis.

2. The method according to claim 1, further comprising an edge extracting an extracted end-face edge for identifying the end-face edge.

3. The method according to claim 2, wherein the course of the extracted end-face edge is analyzed with regard to the deviation from flatness.

4. The method according to claim 3, wherein, for the analysis, the extracted end-face edge is approximated with a curve fit and a resulting mathematical function is analyzed with regard to a deviation from flatness.

5. The method according to claim 1, wherein the sheets are inspected with regard to twisting.

6. The method according to claim 1, wherein a measurement of a distance of surface regions of the particular sheet with respect to a reference height is dispensed with.

7. The method according to claim 1, wherein markers which are correlated with the test region, are fixed in place in the region of the conveyor belt, wherein the camera also captures the markers so that these markers are contained in the captured image (I).

8. The method according to claim 7, wherein the position of the markers in the captured image (I) is analyzed and it is inspected whether the test region depicted in the captured image (I) is oriented according to a specified target orientation.

9. The method according to claim 1, wherein, due to the arrangement of the camera obliquely in front of the test region, the captured image (I) has a vanishing point perspective, and that a correction of the vanishing point perspective is carried out automatically.

10. The method according to claim 1, wherein a plurality of individual sheets are arranged next to one another on the conveyor belt and an automatic individual sheet recognition is carried out, wherein longitudinal structures are analyzed for this purpose and information from a production unit control system is also used.

11. The method according to claim 1, wherein a plurality of individual sheets are arranged next to one another on the conveyor belt and, for each individual sheet, it is inspected whether there is a deviation from flatness.

12. The method according to claim 1, wherein the camera is simultaneously used for a visual monitoring system for visual manual monitoring by operating personnel.

13. The method according to claim 1, wherein the camera has a resolution in the millimeter range.

14. A corrugated cardboard production unit comprising:
at least one conveyor device extending in a longitudinal direction and arranged for conveying corrugated cardboard sheets, wherein the sheets are placed so as to lie partially on top of one another on the conveyor belt during operation, so that an end-face edge of a leading sheet rests on a trailing sheet;
a defined region of the conveyor device is specified as a test region;
at least one camera configured to capture images of the test region, wherein when viewed in the longitudinal direction, the camera is positioned upstream of the test region and is oriented obliquely towards the test region and thus towards the end-face edge of an inspected sheet located in the test region; and
an analysis unit configured to analyze the course of the end-face edge with regard to a deviation from flatness of the inspected sheet by means of an automatic image analysis on the basis of at least one of the captured images (I).

15. A corrugated cardboard production unit comprising:
at least one conveyor device extending in a longitudinal direction for conveying sheets made of corrugated cardboard;
a defined region of the conveyor device as a test region;
at least one camera configured to capture images (11) of the test region, wherein the camera is oriented towards the test region in order to capture images showing the test region;
an enclosure covering the conveyor device and attached in the region of the test region; and
a lighting element which illuminates at least part of the test region.

16. The corrugated cardboard production unit according to claim 15, in which one or more of the following features is/are realized:
a) the lighting element can be dimmed and/or the light color can be set,
b) a cone of light emanating from the lighting element is oriented obliquely in the direction of the test region,
c) the lighting element is attached to an inner side of the enclosure,
d) the enclosure has at least one side wall,
e) the lighting element is attached and/or shaded such that the lighting element is not visible to the camera and/or the light output by the lighting element does not shine into the camera,
f) the enclosure is made of an opaque material,
g) the enclosure is formed only in the region of the test region and has a length in the longitudinal direction that is adjusted to the length of the test region,
h) the lighting element extends transversely to the longitudinal direction and has a plurality of individually controllable regions which can be controlled individually or in groups.
